(19) United States
(12) Patent Application Publication
(10) Pub. No.: US 2005/0280349 A1
(43) Pub. Date: Dec. 22, 2005

(54) Display device

(76) Inventors: Masaki Nishikawa, Chiba (JP); Masahiro Nishizawa, Mobara (JP); Hidetsugu Matsukiyo, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/151,259

(22) Filed: Jun. 14, 2005

(30) Foreign Application Priority Data
Jun. 18, 2004 (JP) 2004-180925

(51) Int. Cl. H01J 1/62

(52) U.S. Cl. 313/496

(57) ABSTRACT

An image display device includes phosphor layers which are formed on an inner surface of a light transmitting face plate, a black matrix film which is formed on the inner surface of the face plate in a state that the black matrix film defines the phosphor layers into phosphor layers of respective colors, and electron beam sources which are arranged in the inside of the evacuated envelope in a state that the electron beam sources face the phosphor layers in an opposed manner and irradiates electron beams to the phosphor layers. An area occupying ratio of the black matrix film as viewed from an image display screen side of the face plate is set within the range of 60% to 95%.

### BACKGROUND OF THE INVENTION

The present invention relates in general to an image display device, and, more particularly, the invention relates to an image display device in which a charging of the phosphor layers by a black matrix film, which is formed on an inner surface of a face plate, is suppressed, thus achieving a high brightness, a high contrast and a prolonged lifetime.

In general, with respect to a color cathode ray tube, which constitutes a typical example of a commonly used image display device, a phosphor screen is provided on an inner surface of a face plate, which constitutes a front surface portion of an envelope, with the phosphor screen consisting of the sequential arrangement of a black matrix film, a phosphor film, a metal back film, a shadow mask and the like. Further, an electron gun is arranged inside of a neck portion of the envelope. Still further, a deflection yoke is arranged outside the neck portion. Due to such a constitution, electron beams which are irradiated from the electron gun are deflected by a magnetic field generated by the deflection yoke, with the result that the phosphor screen is scanned by electron beams passing through the shadow mask, thus displaying an image on the phosphor screen.

Recently, as a means to enhance the image characteristics in a color cathode ray tube, such as the brightness and the contrast, a color cathode ray tube having the following constitution has been disclosed in JP-A-11-224616 (patent literature 1). That is, in a color cathode ray tube which has an optical filter layer on an inner surface of a panel of a face plate, a transparent conductive film made of ITO (indium-tin-oxide) or ATO (antimony oxide film) is arranged between the filter layer and a phosphor layer; and, hence, a lowering of the light emitting brightness attributed to the charging of the phosphor layer can be prevented, thus enhancing the display characteristics, such as the brightness and the contrast.

Further, JP-A-8-315748 (patent literature 2) discloses a color cathode ray tube in which a phosphor screen having a black matrix film, a metal back film, and a shadow mask are arranged on an inner surface of a panel of a face plate, and a transparent conductive film made of SiO₂ (tin oxide) or the like is closely adhered to the inner surface of the panel; hence, the charging property of the surface of a phosphor layer is improved, thus enhancing the display characteristics, such as the brightness and the contrast.

Further, JP-A-10-116568 (patent literature 3) discloses a phosphor thin film and a method of manufacture thereof having the following constitution. That is, on a substrate which corresponds to an inner surface of a panel, transparent electrodes which are formed in a stripe pattern, phosphor thin films which are formed in a stripe pattern on the transparent electrodes, and a charge preventing film which is formed on the phosphor thin films are provided, and the transparent electrodes and the phosphor thin films are separated from each other by non-light emitting walls in a stripe pattern. Due to such a constitution, phosphor thin films having high definition can be easily formed, and, hence, a miniaturized field emission type phosphor display device having a high definition can be realized.

Further, JP-A-2001-216925 (patent literature 4) discloses an image display device having the following constitution. That is, to form a phosphor forming portion of one pixel region which constitutes a phosphor screen in a concave shape so as to have a display surface that is larger than a projection area, as viewed from a substrate side, a black matrix film is constituted to have a two-layered structure made of graphite and alumina.

Further, JP-A-11-339683 (patent literature 5) discloses a cathode ray tube and a method of manufacture thereof. That is, a phosphor screen surface, which is constituted of a black matrix film, a light reflection film which is formed on the black matrix film, a large number of phosphor films which are provided to cover gaps formed in the black matrix film, and a back light reflection film formed on the light reflection film and the phosphor film, is formed on an inner surface of a panel, wherein the back light reflection film covers the phosphor films so as to insulate a phosphor film from a neighboring phosphor film, and minute irregularities are formed on a surface of the backlight reflection film at a side which is brought into contact with the phosphor films, thus enhancing the phosphor light emission takeout efficiency.

### SUMMARY OF THE INVENTION

In the color cathode ray tubes described in patent literature 1 and patent literature 2, the transparent conductive film has ITO (indium tin oxide), ATO (antimony tin oxide), SnO₂ (tin oxide) or the like as a main component; however, these substances exhibit a coloring of brown apparently upon irradiation of the electron beams thereto, and so the colored portion is converted into a coloring layer. There has been a drawback in that this coloring layer decreases the light emitting brightness of the phosphor layer, along with an increase in the use time due to a filter effect thereof.

Further, in the phosphor thin film described in patent literature 3, since the phosphor thin film is typically formed by a printing technique, there is difficulty in narrowing the width of a phosphor pattern produced thereby and, at the same time, it is difficult to accurately control the width of the phosphor pattern. For example, the formation of a pattern width of approximately 10 μm or less, for example, is difficult. Since general phosphors for low-speed electron beams have a particle size of several μm or more, there have been drawbacks in that the light emitting efficiency is lowered along with a demand for phosphor powder particles having finer particle sizes, and impurities are easily produced. Further, there has been a drawback in that a charging of the phosphor thin film is easily generated due to the irradiation of electron beams.

Accordingly, the present invention has been made to overcome the above-mentioned conventional drawbacks, and it is an object of the present invention to provide an image display device in which the charging of a phosphor layer can be suppressed, and in which the display characteristics, such as the brightness and the contrast, can be enhanced by properly setting an area occupying ratio of a black matrix film, as viewed from an image display screen side of a face plate, thus increasing the contact area between the phosphor layer and the black matrix film.

Further, it is another object of the present invention to provide an image display device which effectively makes use of electron beams and in which the display characteristics, such as the brightness and the contrast, can be enhanced by forming a metal layer having a small surface resistance value on a surface of the black matrix film.

To achieve these objects, an image display device according to the present invention includes an evacuated envelope which has a light transmitting face plate, phosphor layers which are formed on an inner surface of the face plate, a black matrix film which is formed on the inner surface of the face plate in a state such that the black matrix film defines the phosphor layers, and electron beam sources which are arranged inside of the evacuated envelope in a state such that the electron beam sources face the phosphor layers in an opposed manner and irradiate electron beams to the phosphor layers, wherein the area occupying ratio of the black matrix film, as viewed from an image display screen side of the face plate, is set within a range of 60% to 95%. By increasing the contact area between the phosphor layers and the black matrix film in this manner, the charging of the phosphor layers attributed to the irradiation of electron beams can be suppressed, and, hence, it is possible to overcome the drawbacks of the related art.

Further, another image display device according to the present invention includes an evacuated envelope which has a light transmitting face plate, phosphor layers which are formed on an inner surface of the face plate, a black matrix film which is formed on the inner surface of the face plate in a state such that the black matrix film defines the phosphor layers, and electron beam sources which are arranged in the inside of the evacuated envelope in a state such that the electron beam sources face the phosphor layers in an opposed manner and irradiate electron beams to the phosphor layer, wherein the area occupying ratio of the black matrix film, as viewed from an image display screen side of the face plate, is set within a range of 83% to 94%. By increasing the contact area between the phosphor layers and the black matrix film in this manner, the charging of the phosphor layers, which is attributed to the irradiation of electron beams, can be suppressed, and, hence, it is possible to overcome the drawbacks of the related art.

Further, it is preferable that, in the above-mentioned constitution, a metal layer is formed on at least one surface of the black matrix, and metal back films are formed on upper surfaces of the phosphor layers. By bringing the phosphor layers into contact with the metal layer, the charging of the phosphor layers, which is attributed to the irradiation of electron beams, can be further suppressed, and, hence, the drawbacks of the related art can be overcome.

Further, it is preferable that, in the above-mentioned constitution, by setting the surface resistance of the metal layer to a value that is smaller than the value of the surface resistance of the metal back film, the voltage drop of the metal layer is decreased, and, hence, the electrons are attracted to the inner surface side of the face plate and intrude deeply into the phosphor layers, whereby it is possible to effectively make use of the electrons, thus overcoming the drawbacks of the related art.

Further, it is preferable that, in the above-mentioned constitution, by setting the surface resistance value of the metal layer to 50% or less of the surface resistance value of the metal back film, the voltage drop of the metal layer is decreased, and, hence, the electrons are attracted to the inner surface side of the face plate and intrude deeply into the phosphor layers, whereby it is possible to effectively make use of the electrons, thus overcoming the drawbacks of the related art.

Further, it is preferable that, in the above-mentioned constitution, by setting the film thickness of the metal back film formed on the electron source side so that it is smaller than the thickness of the metal layer formed on the black matrix film, the voltage drop of the metal layer is decreased, and, hence, the electrons are attracted to the inner surface side of the face plate and intrude deeply into the phosphor layers, whereby it is possible to effectively make use of the electrons, thus overcoming the drawbacks of the related art.

The present invention is not limited to the above-mentioned respective constitutions and the constitutions described in connection with the embodiments to be explained later, and it is needless to say that various modifications can be made without departing from the technical concept of the present invention.

According to the image display device of the present invention, by increasing the contact area between the phosphor layers and the black matrix film, the charging of the phosphor layers attributed to the irradiation of electron beams can be prevented, and, hence, the light emitting intensity of the phosphor layers can be increased and, at the same time, the contrast of the phosphor layers also can be simultaneously enhanced. Accordingly, the image display device of the present invention can produce extremely excellent advantageous effects, such as the acquisition of display images of high brightness and high contrast.

Further, according to the image display device of the present invention, by providing the metal layer on at least one surface of the black matrix, the charging prevention effect of the phosphor layers can be further enhanced, and, hence, the image display device can produce extremely excellent advantageous effects, such as the acquisition of display images of high brightness and high contrast.

Further, according to the image display device of the present invention, by setting the surface resistance of the metal layer to a value that is lower than the value of the surface resistance of the metal back film, the voltage drop of the metal layer is reduced, and, hence, the electron beams deeply intrude into the phosphor layers, thus diffusing the electrons in the phosphor layers, whereby it is possible to effectively make use of the electron beams. Accordingly, the image display device can produce extremely excellent effects, such as the acquisition of display images of high brightness and high contrast.

### BRIEF DESCRIPTION OF THE DRAWINGS

FIG. 1 is a cross-sectional view showing the constitution of a field emission type display panel according to one embodiment of an image display device of the present invention;

FIG. 2 is an enlarged cross-sectional view showing a portion A in the field emission type display panel shown in FIG. 1;

FIG. 3 is an enlarged plan view of a phosphor screen formed on an inner surface of a face plate of the field emission type display panel shown in FIG. 1, as viewed from an image display screen side;

FIG. 4 is an enlarged plan view showing the constitution of a phosphor screen formed on an inner surface of a face plate of a field emission type display panel shown in FIG. 1, as viewed from an electron source side;

FIG. 5 is an enlarged cross-sectional view showing the constitution of a phosphor screen formed on an inner surface of a face plate of a currently available display panel;

FIG. 6 is an enlarged plan view showing the constitution of a phosphor screen formed on an inner surface of a face plate of a currently available display panel, as viewed from an electron source side;

FIG. 7 is an enlarged cross-sectional view showing the constitution of another embodiment of a phosphor screen formed on an inner surface of a face plate of a field emission type display panel of the present invention;

FIG. 8(a), FIG. 8(b) and FIG. 8(c) are enlarged cross-sectional views of a glass panel portion which illustrate why it is possible to enhance the diffusion property of electron beams in the inside of phosphors on which a metal layer is formed; and

FIG. 9 is an enlarged cross-sectional view showing the constitution of still another embodiment of the phosphor screen formed on the inner surface of the face plate of the field emission type display panel according to the present invention.

### DESCRIPTION OF THE PREFERRED EMBODIMENTS

Specific embodiments of the present invention will be explained in detail in conjunction with the drawings.

### Embodiment 1

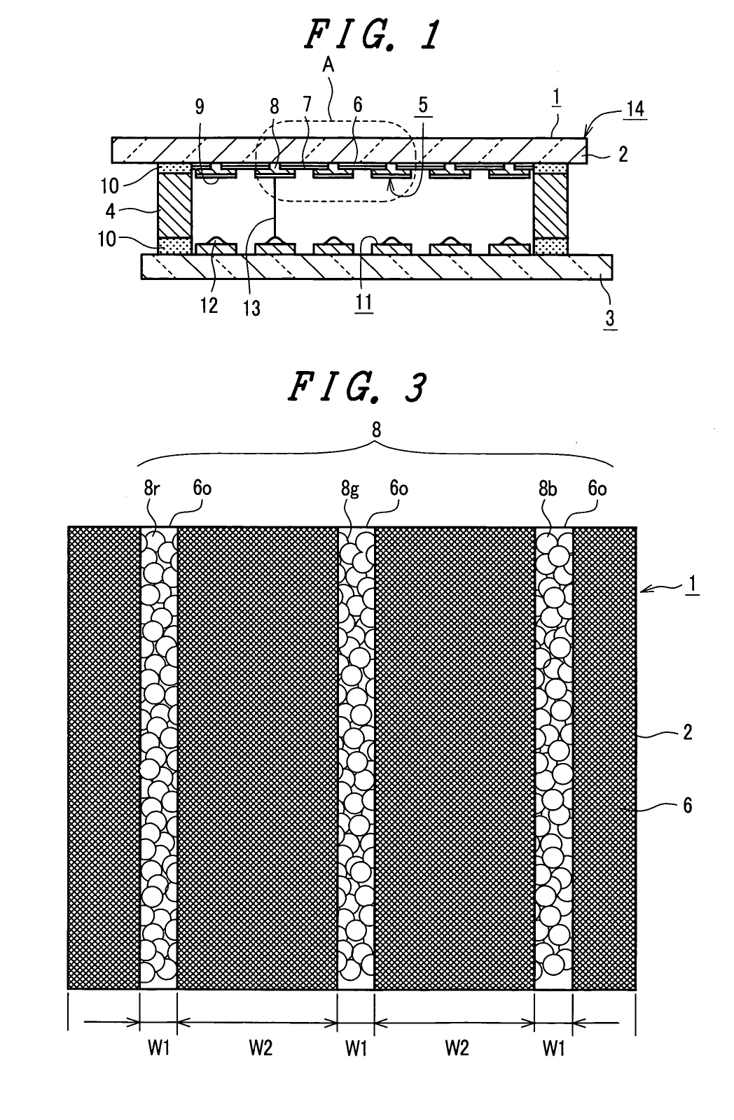

FIG. 1 is a schematic cross-sectional view showing the constitution of a field emission type display panel according to an embodiment 1 of an image display device of the present invention. In FIG. 1, numeral 1 indicates a front glass panel portion, numeral 2 indicates a face plate, numeral 3 indicates a back panel portion, numeral 4 indicates a sealing frame portion, numeral 5 indicates a phosphor screen, numeral 6 indicates a black matrix film, numeral 7 indicates a metal layer, numeral 8 indicates phosphor layers, numeral 9 indicates a metal back film, numeral 10 indicates a sealing material, numeral 11 indicates a group of electron emission elements, numeral 12 indicates electron beam sources, numeral 13 indicates a representative one of the electron beams irradiated from the electron beam sources 12, and numeral 14 generally indicates a field emission type display panel formed of the aforementioned elements.

A glass-made evacuated envelope (bulb) which constitutes the field emission type display panel 14 is constituted of the front glass panel portion 1, having the light transmitting face plate 2, the back panel portion 3, which has the electron beam sources 12 formed in the inside thereof, and the sealing frame portion 4, which connects the face panel portion 1 and the back panel portion 3.

The face glass panel portion 1 is constituted of the phosphor screen 5, which has a three-layered structure consisting of the black matrix film 6, the metal layer 7 and the phosphor layers 8 formed on the inner surface of the panel of the face plate 2, and the metal back film 9, which is formed on the phosphor screen 5.

Further, the group of electron emission elements 11 are formed on the inside of the back panel portion 3, wherein the electron beams 13, which are irradiated from the electron beam sources 12, impinge on the phosphor screen 5.

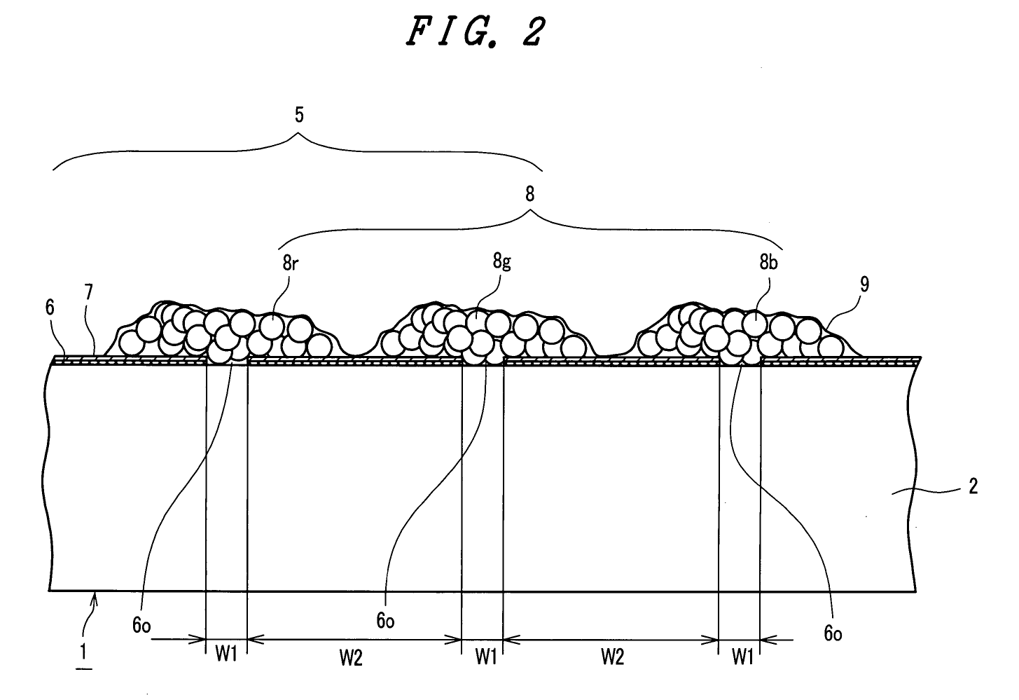

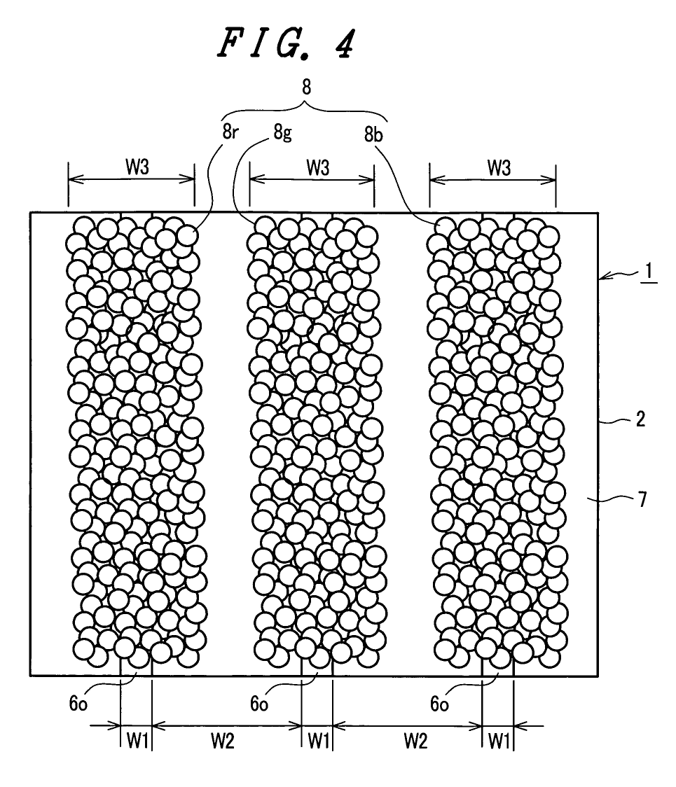

FIG. 2 to FIG. 4 are views which show the specific structure of a portion A of the phosphor screen 5 formed on the panel inner surface of the face plate 2 of the field emission type display panel shown in FIG. 1, wherein FIG. 2 is an enlarged cross-sectional view of the structure, FIG. 3 is an enlarged plan view of the structure as viewed from an image display screen side, and FIG. 4 is an enlarged plan view of the structure as viewed from an electron beam source side. Parts identical with the parts shown in the above-mentioned FIG. 1 are identified by the same symbols. In FIG. 2, on the panel inner surface of the face plate 2, on which the phosphor screen 5 is formed, a black matrix film 6, having stripe-patterned apertures 6o with an aperture width W1 of approximately 20 μm that constitute irradiated light takeout openings formed in phosphor layers of respective colors, to be described later, is alternately and repeatedly formed with a width W2 of approximately 150 μm.

The black matrix film 6 is, as shown in FIG. 3, formed such that an area occupying ratio thereof within an image display region of the face plate 2 falls within a range of 60% to 98%. Further, as shown in FIG. 2 and FIG. 4, on the black matrix film 6, a metal layer 7, which is made of an aluminum material having high conductivity, is formed as a film having a thickness of approximately 100 nm. In this case, the inner surface of the glass panel of the face plate 2 is exposed inside of the respective openings 6o of the black matrix film 6, and the metal layer 7 is not formed in the respective openings 6o. Accordingly, the respective openings of the metal layer 7 are also aligned with the respective openings 6o of the black matrix film 6 and are formed to have the same shape as the respective openings 6o formed in the black matrix film 6.

Further, on the metal layer 7, as shown in FIG. 4, the phosphor layers 8r, 8g, 8b of respective colors, consisting of red, green and blue, and having a width W3 of approximately 120 μm, are formed in a stripe arrangement such that the respective phosphor layers 8r, 8g, 8b cover the respective openings 6o, which have a width W1 of approximately 20 μm, in a wide range. By allowing the electron beams 13 to impinge on the respective phosphor layers 8r, 8g, 8b, the phosphor layers 8r, 8g, 8b of respective colors on the phosphor screen 5 emit lights of colors which correspond to the phosphor layers 8r, 8g, 8b, thus producing an image display.

Next, the manner of forming the phosphor screen 5 having such a constitution will be explained in detail. First of all, a photosensitive element containing polyvinyl alcohol and ammonium bichromate as main components is applied to the inner surface of the glass panel of the face plate 2 so as to form a photosensitive film. Next, ultraviolet rays are irradiated to the phosphor screen 5 using a mask, such that photosensitive curing layers having a width W1 of approximately 20 μm are arranged in a stripe pattern at an interval W2 of approximately 150 μm, and, thereafter, they are developed. Next, a graphite slurry is applied to the inner surface of the glass panel and is dried so as to form the black matrix film 6.

Subsequently, the metal layer 7, made of an aluminum material and having a thickness of approximately 100 nm, is formed on the black matrix film 6 by a vapor deposition method. Next, the face plate 2 is immersed in a hydrogen peroxide solution to swell the photosensitive cured layers, and the swelled photosensitive cured layers are washed away with hot water spraying. Here, the black matrix film 6 and the metal layer 7, which are formed on the photosensitive cured layers, are washed away with the photosensitive cured layers. Accordingly, on the inner surface of the glass panel of the face plate 2, layers which are formed by stacking the black matrix film 6 and the metal layer 7 remain with a width W2 of approximately 150 μm and at an interval W1 of approximately 20 μm. In portions having the interval W1 of approximately 20 μm, the inner surface of the panel of the face plate 2 is exposed, thus forming the openings 6o.

Subsequently, phosphor pastes of respective colors are printed with a width W3 of approximately 120 μm, using the opening 6o having the W1 of approximately 20 μm as the center, by means of a printing method. In this case, the phosphor layers 8 (8r, 8g, 8b) are stacked on the metal layer 7 at portions having a width of approximately 50 μm from both end portions of the opening 6o. Subsequently, an acrylic emulsion is applied to the phosphor layers 8 to form filming films, and the films are dried. Here, the viscosity and the drying speed of the acrylic emulsion is controlled so as to prevent the acrylic emulsion from reaching at least portions on the metal layer 7 where the phosphor layers 8 are not present.

Next, after forming the metal back film 9 made of aluminum on the filming films and the metal layer 7 by a vapor deposition method, panel baking is performed to obtain the face glass panel portion 1. Here, the area occupying ratio of the black matrix film 6, as viewed from the display screen side, becomes width W2/(width W1+width W2)=88.2%. The face glass panel portion 1, which is obtained in this manner, is bonded to the back panel portion 3 on which the sealing frame portion 4 and the electron beam sources 12 are formed. Thereafter, the vacuum evacuation is performed to complete the field emission type display panel.

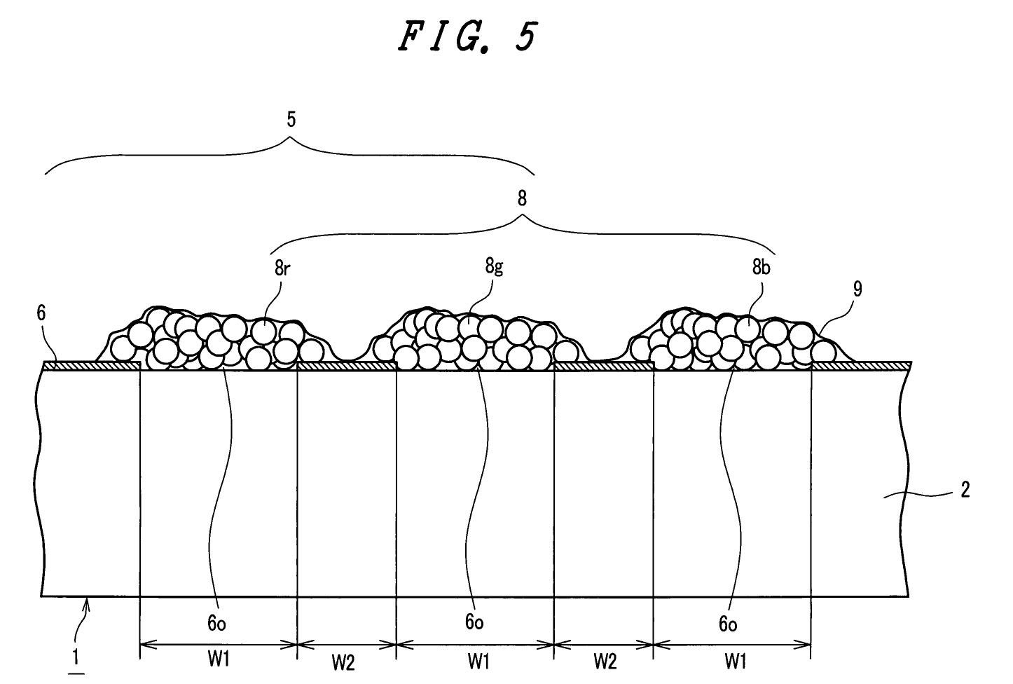

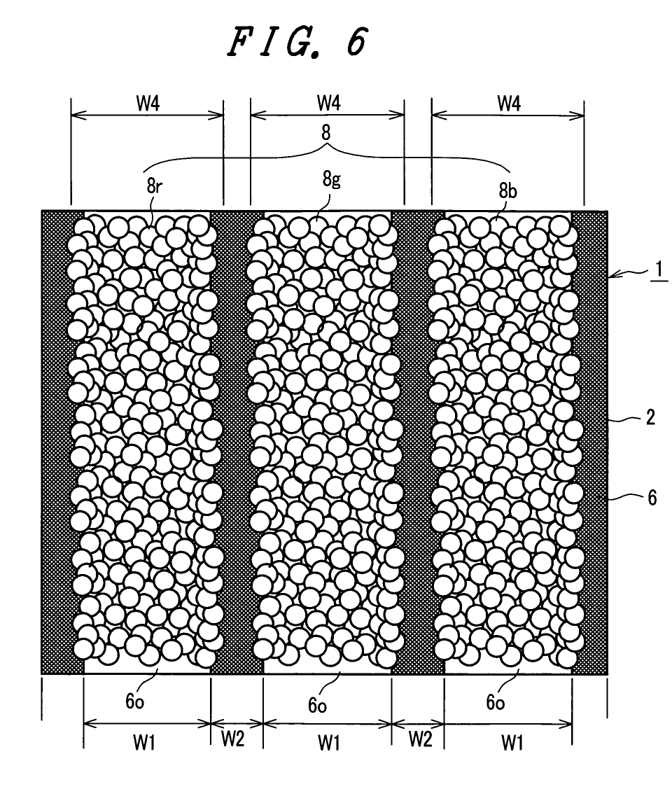

FIG. 5 and FIG. 6 show the specific structure of a phosphor screen formed on an inner surface of a face plate of a currently-available display panel as a comparison example, wherein FIG. 5 is an enlarged cross-sectional view and FIG. 6 is an enlarged plan view as viewed from the electron source side. Parts identical with the parts in the above-mentioned drawings are identified by the same symbols. In these drawings, on the panel inner surface of the face plate 2 which forms the phosphor screen, the black matrix film 6, having the openings 60 in a stripe pattern with an opening width W1 of approximately 120 μm, which constitute the emitted light takeout openings of the phosphor layers 8r, 8g, 8b of respective colors, is alternately and repeatedly formed with a width W2 of approximately 50 μm.

Here, the width W4 of the phosphor layers 8r, 8g, 8b of respective colors is approximately 140 μm, and the peripheries having approximately 10 μm at both end portions of the phosphor layers 8r, 8g, 8b of respective colors, are formed in a state such that the phosphor layers 8r, 8g, 8b extend over the black matrix film 6. In this case, the area occupying ratio of the black matrix film 6, as viewed from the image display screen side, becomes width W2/(width W1+width W2)=29.4%. The face glass panel portion 1 which is obtained in this manner is bonded to the back panel portion 3 on which the sealing frame portion 4 and the electron beam sources 12 are formed. Thereafter, the vacuum evacuation is performed to complete the display panel.

The display panel which was prepared in the embodiment 1 and the currently available display panel which was prepared for the comparison purposes were driven and the brightness of both panels was measured. As a result of the measurement, assuming that the brightness of the currently available display panel is 100%, the brightness of the display panel of the embodiment 1 becomes approximately 102%. Further, the display panel of the embodiment 1 can also exhibit a remarkably enhanced contrast. That is, assuming that the contrast of the currently available display panel as 1.0, the contrast of the display panel of the embodiment 1 is approximately 2.4 times as large as the contrast of the currently available display panel. The reason why the contrast of the display panel of the embodiment 1 is enhanced is attributed to the increase of the area occupying ratio of the black matrix film 6, as viewed from the image display screen side. Further, it has been clearly found that the reason why the brightness is enhanced is attributed to the fact that the charging of the phosphor layers 8 is suppressed, and, hence, the electron beams 13 can be more effectively used.

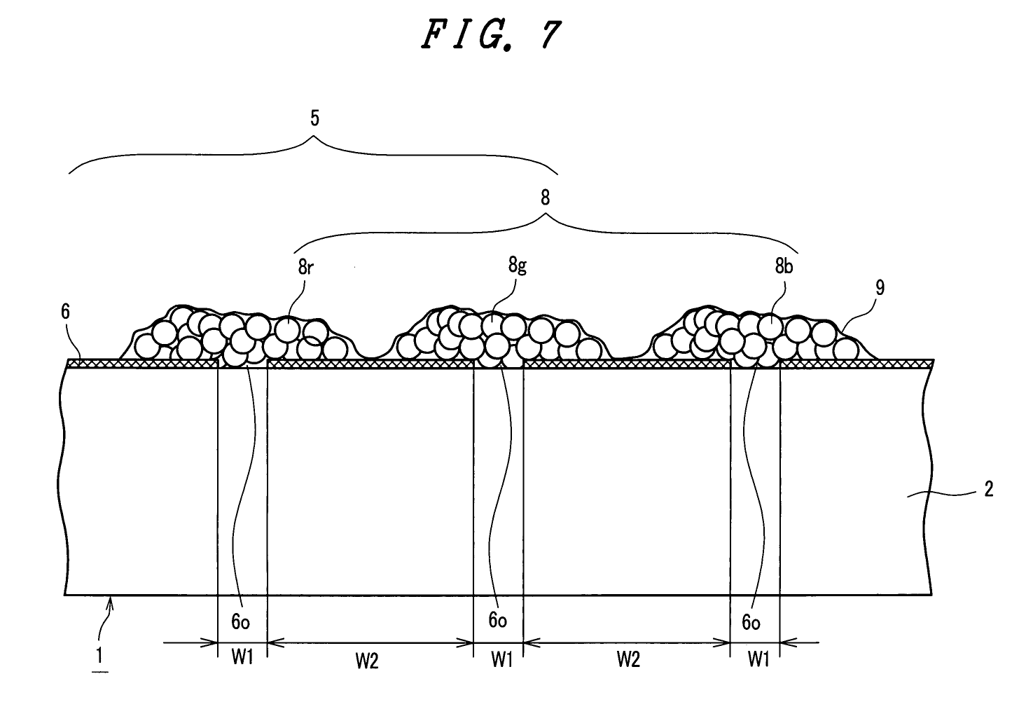

Here, in the above-mentioned embodiment 1, an explanation has been given with respect to a case in which the black matrix film 6 having the opening 6o in a stripe pattern is formed on the panel inner surface of the face plate 2, and, thereafter, the metal layer 7 is formed on the black matrix film 6, and the respective phosphor layers 8r, 8g, 8b are formed on the respective openings formed in the metal layer 7. However, as shown in FIG. 7, which is an enlarged cross-sectional view, by forming the respective phosphor layers 8r, 8g, 8b on the respective openings 6o of the black matrix film 6 having the stripe-patterned openings 6o, the contact area where the respective phosphor layers 8r, 8g, 8b and the black matrix film 6 come into contact with each other is increased, and, hence, the charging of the phosphor layers 8r, 8g, 8b attributed to the irradiation of the electron beams 13 can be suppressed. In this case, the black matrix film 6 is formed using a light absorbing material, such as graphite, which exhibits a high conductivity.

Further, although the black matrix film 6 is formed using a photolithography method in the above-mentioned embodiment 1, it is possible to use a printing method. Further, although an explanation has been given with respect to a case in which the black matrix film 6 is formed in a stripe pattern, the black matrix film 6 may be formed in a dot-blanked pattern or in a grid array.

### Embodiment 2

Front glass panel portions 1, in which the width W2 of the black matrix film 6 formed on the panel inner surface of the face plate 2 is changed in a range from approximately 50 μm to approximately 167 μm, as shown in following Table 1, are manufactured using a technique similar to the technique used in the embodiment 1, and these glass panel portions 1 are completed as display panels. The measured values of the brightness and the contrast of the respective completed display panels are shown in Table 1. As can be clearly understood from Table 1, the contrast is increased along with the increase of the area occupying ratio of the black matrix film 6. Further, the brightness is enhanced when the area occupying ratio falls within a range of more than approximately 60% and less than approximately 95%. It is also confirmed that the brightness becomes large, specifically, within a range of more than approximately 70.6% and less than approximately 94.1% and, more favorably, within a range of more than approximately 82.4% and less than approximately 94.1%.

TABLE 1

| | | | | | | | | | | | | Prior |
|---|---|---|---|---|---|---|---|---|---|---|---|---|
| | Embodiment 2 | | | | | | | | | | | art 1 |
| Black matrix width (W2) (μm) | 167 | 165 | 160 | 150 | 140 | 130 | 120 | 110 | 100 | 90 | 70 | 50 |
| Phosphor width (W1) (μm) | 3 | 5 | 10 | 20 | 30 | 40 | 50 | 60 | 70 | 80 | 100 | 120 |
| Black matrix occupying ratio (%) | 98.2 | 97.1 | 94.1 | 88.2 | 82.4 | 76.5 | 70.6 | 64.7 | 58.8 | 52.9 | 41.2 | 29.4 |
| Contrast (ratio) | 25.0 | 19.8 | 12.0 | 6.0 | 4.0 | 3.0 | 2.4 | 2.0 | 1.7 | 1.5 | 1.2 | 1.0 |
| Relative brightness (%) | 64 | 83 | 102 | 103 | 103 | 102 | 102 | 101 | 101 | 100 | 100 | 100 |

### Embodiment 3

The black matrix film 6 was formed on the inner surface of the panel of the face plate 2 using the steps described in connection with the embodiment 1. Subsequently, the metal layer 7 made of an aluminum material was formed on the black matrix film 6 using a vacuum vapor deposition method. Here, six types of front glass panel portions 1, having the thicknesses of the metal layer 7 of approximately 50 μm, approximately 100 μm, approximately 150 μm, approximately 200 μm, approximately 300 μm and approximately 500 μm, were manufactured. Each one of these front glass panel portions 1 was bonded to a back panel portion 3, on which the sealing frame portions 4 and electron beam sources 12 are formed, and vacuum evacuation was performed, whereby these front glass panel portions 1 were completed as display panels. The evaluations of these display panels were conducted substantially in the same manner as the embodiment 1. The comparison results are shown in the following Table 2.

TABLE 2

| | | | | | | | prior |
|---|---|---|---|---|---|---|---|
| | embodiment 3 | | | | | | art 1 |
| metal layer | 50 | 100 | 150 | 200 | 300 | 500 | none |
| thickness (nm) | | | | | | | |
| relative | 101 | 102 | 102 | 103 | 103 | 103 | 100 |
| brightness (%) | | | | | | | |

As can be clearly understood from Table 2, along with an increase of the thickness of the metal layer 7, the brightness is increased. This implies that, by decreasing the resistance value with an increase of the thickness of the metal layer 7, the potential which the metal layer 7 generates further approximates the potential applied to the inner surface of the panel, and, hence, the irradiated electron beams 13 are further easily diffused on the front glass panel portion 1 side.

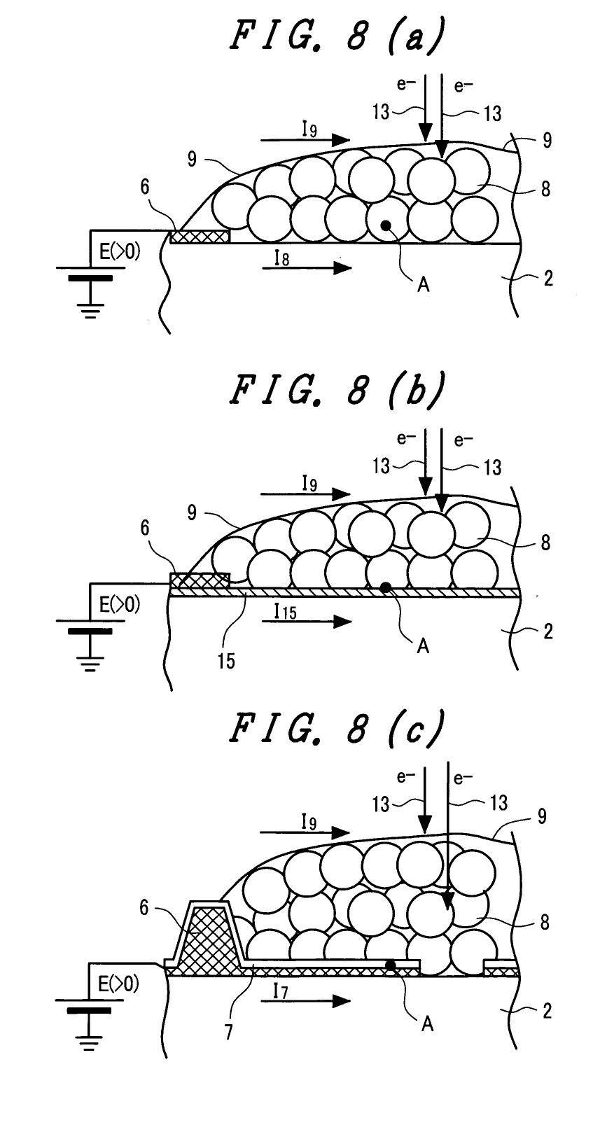

FIG. 8(a), FIG. 8(b) and FIG. 8(c) are enlarged cross-sectional views of the front glass panel portion 1 illustrating why the enhancement of the diffusion property of the electron beams 13 to the inside of the phosphor layer 8 can be obtained by forming the above-mentioned metal layer 7. FIG. 8(a) and FIG. 8(b) show the constitutions of conventional structures and FIG. 8(c) shows the constitution according to the present invention. Here, parts identical with the parts shown in the above-mentioned drawings are identified by the same symbols and a repeated explanation thereof is omitted. In FIG. 8(a), FIG. 8(b) and FIG. 8(c), the surface resistance value of the metal layer 7 is set as R₇, the surface resistance value of the phosphor layer 8 is set as R₈, the surface resistance value of the metal back film 9 is set as R₉ and the surface resistance value of the transparent conductive film 15 is set as R₁₅.

Further, the current which flows at a point A, which is separated from one end of the metal layer 7 by a given distance is set as I₇, the current which flows at the same point A of the phosphor 8 is set as I₈, the current which flows in the same point A of the transparent conductive film 15 is set as I₁₅, the current which flows in the metal back film 9 is set as I₉, and the potentials at the respective points A are set as Va, and an anode voltage E (E>0) is applied to the black matrix film 6.

Here, for reference purposes, the surface resistance value R₆ of the black matrix film 6 is 1000 to 100000 Ω when the film thickness thereof is approximately 1 μm, the surface resistance value R₉ of the metal back film 9 is approximately 0.5 Ω when the film thickness thereof is approximately 100 nm, the surface resistance value R₁₅ of the transparent conductive film 15 is approximately 100 when the film thickness thereof is approximately 150 nm.

The surface resistance value R₇ of the metal layer 7, which is formed on the inner panel surface of the face plate 2, is set to be lower than the surface resistance value R₉ of the metal back film 9. Accordingly, when the electric beams 13 are irradiated, the current 17 flows in the metal layer 7 and the current 19 flows in the metal back film 9. Here, voltage drops are generated in both the metal layer 7 and the metal back film 9 and the effective anode voltage E is lowered. However, by setting the resistance value R₇ of the metal layer 7 at a low value, the voltage drop of the metal layer 7 becomes smaller than the voltage drop of the metal back film 9, and, hence, the potential of the metal layer 7 is held higher than the potential of the metal back film 9. Accordingly, the electrons e⁻ are attracted to the panel inner surface side and penetrate deeply into the film thickness of the phosphor 8, as shown in FIG. 8(c), and are diffused, whereby the electrons e⁻ can be efficiently utilized. The comparison results are shown in the following table 3.

TABLE 3

| | | prior art 2 | present | present |
|---|---|---|---|---|
| | prior art 1 | (with ITO) | invention 1 | invention 2 |
| relationship | (R₉ << R₈) | (R₉ < R₁₅) | (R₉ ≅ R₇) | (R₉ > R₇) |
| between | | | | |
| resistance | | | | |
| values | | | | |
| voltage drop | large | medium | small | very small |
| to point A | | | | |
| potential at | Va <<< E | Va << E | Va < E | Va ≅ E |
| point A | | | | |
| diffusion of | narrow | usual | wide | wider |
| irradiated | | | | |
| electrons | | | | |

Here, since the resistance value R₈ of the phosphor layer 8 is extremely high compared to the resistance value R₇ of the metal layer 7 and the resistance value R₉ of the metal back film 9, the current distribution to the metal layer 7 and the metal back film 9 is controlled by the electron diffusion distribution into the inside of the phosphor layer 8.

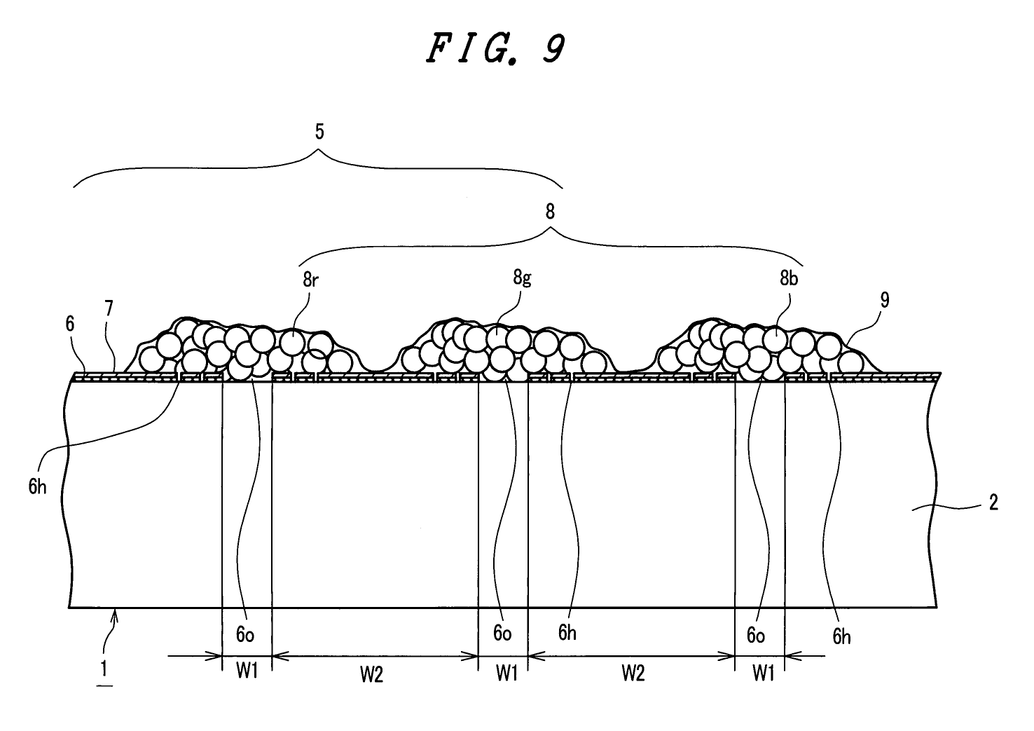

FIG. 9 is an enlarged cross-sectional view showing the constitution of still another embodiment of the phosphor screen which is formed on the inner surface of the face plate of a field emission type display panel according to the present invention, and parts identical with the parts shown in the above-mentioned FIG. 2 are identified by the same symbols and a repeated explanation thereof is omitted. The constitution shown in FIG. 9 differs from the constitution shown in FIG. 2 in that, in the two-layered structure consisting of the metal film 7 and the black matrix film 6, with which the respective phosphor layers 8r, 8g, 8b are brought into contact, a plurality of small holes 6h, having a small opening diameter are formed to penetrate the two-layered structure.

Here, the plurality of small holes 6h can be formed during the same process as a process for forming the stripe-patterned openings 6o which are formed in the black matrix film 6. In such a constitution, by forming the plurality of small holes 6h, the emission light quantities of respective phosphor layers 8r, 8g, 8b of light which passes through the respective small holes 6h are increased, and, hence, the brightness can be further enhanced.

Here, in the above-described respective embodiments, an explanation has been given by taking a field emission type display panel as an example of an image display device. However, the present invention is not limited to such a case, and it is needless to say that, the same advantageous effects as described above can be obtained even when the constitution is applied to a color cathode ray tube (CRT) or the like.

1. An image display device comprising:
an evacuated envelope which has a light transmitting face plate;
phosphor layers which are formed on an inner surface of the face plate;
a black matrix film which is formed on the inner surface of the face plate in a state that the black matrix film defines the phosphor layers; and
electron beam sources which are arranged in the inside of the evacuated envelope in a state that the electron beam sources face the phosphor layers in an opposed manner and irradiate electron beams to the phosphor layers, wherein
an area occupying ratio of the black matrix film as viewed from an image display screen side of the face plate is set within the range of 60% to 95%.

2. An image display device comprising:
an evacuated envelope which has a light transmitting face plate;
phosphor layers which are formed on an inner surface of the face plate;
a black matrix film which is formed on the inner surface of the face plate in a state that the black matrix film defines the phosphor layers; and
electron beam sources which are arranged in the inside of the evacuated envelope in a state that the electron beam sources face the phosphor layers in an opposed manner and irradiates electron beams to the phosphor layers, wherein
an area occupying ratio of the black matrix film as viewed from an image display screen side of the face plate is set within the range of 83% to 94%.

3. An image display device according to claim 1, wherein a metal layer is formed on at least one surface of the black matrix film, and a metal back film is formed on upper surfaces of the phosphor layers.

4. An image display device according to claim 3, wherein a surface resistance value of the metal layer is set smaller than a surface resistance value of the metal back film.

5. An image display device according to claim 3, wherein the surface resistance value of the metal layer is set to 50% or less of the surface resistance value of the metal back film.

6. An image display device according to claim 3, wherein a film thickness of the metal layer is set larger than a thickness of the metal back layer.

7. An image display device comprising:
an evacuated envelope which has a light transmitting face plate;
phosphor layers which are formed on an inner surface of the face plate;
a black matrix film which is formed on the inner surface of the face plate in a state that the black matrix film defines the phosphor layers; and
electron beam sources which are arranged in the inside of the evacuated envelope in a state that the electron beam sources face the phosphor layers in an opposed manner and irradiate electron beams to the phosphor layers, wherein
an area occupying ratio of the black matrix film as viewed from an image display screen side of the face plate is set within the range of 70.6% to 94.1%.
